(19) United States
(12) Patent Application Publication
(10) Pub. No.: US 2008/0010678 A1
(43) Pub. Date: Jan. 10, 2008

(54) Authentication Proxy

(76) Inventors: Jeff Burdette, Norcross, GA (US); Richard Cabrera, Norcross, GA (US); David Helsper, Marietta, GA (US)

Correspondence Address: NEEDLE & ROSENBERG, P.C., SUITE 1000, 999 PEACHTREE STREET, ATLANTA, GA, 30309-3915, US

(21) Appl. No.: 11/758,588

(22) Filed: Jun. 5, 2007

Related U.S. Application Data
(63) Continuation-in-part of application No. 11/411,660, filed on Apr. 26, 2006.
Application No. 11/411,660 is a continuation-in-part of application No. 11/209,885, filed on Aug. 23, 2005.
Application No. 11/209,885 is a continuation-in-part of application No. 10/943,454, filed on Sep. 17, 2004.

(51) Int. Cl. H04L 9/00

(52) U.S. Cl. 726/15; 726/12

(57) ABSTRACT

Systems, methods, and computer program products for providing fraud analysis to an application using a proxy and a fraud determination unit are provided. An Online Fraud Mitigation Engine is also provided in embodiments of the present invention for determining fraudulent transactions. Embodiments are also provided for calculating travel velocity and transaction frequency, which are useful for determining a fraudulent transaction. Further embodiments are provided for authenticating a transaction using an object stored on a client device and a behavior profile stored on a server.

### CROSS-REFERENCE TO RELATED APPLICATIONS

This application is a continuation-in-part of U.S. application Ser. No. 11/411,660, filed on Apr. 26, 2006, which is a continuation-in-part of U.S. application Ser. No. 11/209,885, filed on Aug. 23, 2005, which is a continuation-in-part of U.S. application Ser. No. 10/943,454, filed on Sep. 17, 2004, which are each herein incorporated by reference in their entirety.

### BACKGROUND OF THE INVENTION

1. Field of the Invention

The present invention relates to techniques for detecting fraudulent online transactions. In one embodiment, the present invention provides methods, systems, and computer program products for providing transparent fraud analysis for an application that is accessed by a user via a login request. The present invention also provides methods, systems, and computer program products for operating a fraud engine that is capable of accepting an IP address and a number of factors relating to an end user in order to determine whether a transaction is fraudulent.

The present invention also provides methods, systems, and computer program products for calculating a travel velocity between two access locations, determining if a transaction is fraudulent based on a user's travel velocity between two access locations, and determining if a transaction is fraudulent based on a transaction frequency. The present invention further provides methods, systems, and computer program products for authenticating a transaction by comparing one or more factors stored in a cookie on a client device with one or more factors stored in a behavior profile associated with a user.

2. Description of the Related Art

The ease of hiding an identity on the Internet makes it difficult for financial services organizations to carry the “know your customer” mantra to the online world. In 2003 alone, Internet-related fraud accounted for 55% of all fraud reports according to the Federal Trade Commission, up nearly 45% from the previous year. In order for financial services organizations to continue successfully serving more of their customers online, creating a safe and secure environment is a top priority. Accordingly, there is a need and desire for methods, systems, and computer program products for detecting and preventing fraudulent online transactions as well as a need for methods, systems, and computer program products for authenticating online transactions.

### SUMMARY OF THE INVENTION

One embodiment of the present invention provides methods, systems, and computer program products (hereinafter “method” or “methods” for convenience) for providing transparent fraud analysis for an application that is accessed by a user via a login request. In one embodiment, a fraud determination unit is coupled to a proxy that is configured to intercept a login request and to forward the login request to the fraud determination unit, which determines if the login request is fraudulent.

In another embodiment, an end user inputs parameters and rules concerning a particular transaction into the system. Based on the parameters, rules, and other information concerning a particular transaction, the system computes a score associated with the likelihood that the transaction is fraudulent. The score is then compared with various thresholds which may be set by the end user. If the score exceeds the thresholds, then the transaction is determined to be fraudulent. Data regarding the transaction may also be output to the end user. Upon review, the end user may change the fraud status of a given transaction.

Another embodiment of the present invention provides methods, systems, and computer program products for calculating a travel velocity between a first and second access location, utilizing a travel velocity to determine if a transaction is fraudulent, as well as determining if a transaction is fraudulent based upon a computed transaction frequency.

A further embodiment of the present invention provides methods, systems, and computer program products for authenticating a transaction performed by a user operating a client device which contains a cookie, wherein information stored in the cookie is compared with information stored in a behavior profile associated with the user.

It will be apparent to those skilled in the art that various devices may be used to carry out the systems, methods, or computer program products of the present invention, including cell phones, personal digital assistants, wireless communication devices, personal computers, or dedicated hardware devices designed specifically to carry out embodiments of the present invention. While embodiments of the present invention may be described and claimed in a particular statutory class, such as the system statutory class, this is for convenience only and one of skill in the art will understand that each embodiment of the present invention can be described and claimed in any statutory class, including systems, apparatuses, methods, and computer program products.

Unless otherwise expressly stated, it is in no way intended that any method or embodiment set forth herein be construed as requiring that its steps be performed in a specific order. Accordingly, where a method, system, or computer program product claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of embodiments described in the specification.

### BRIEF DESCRIPTION OF THE DRAWINGS

The foregoing and other advantages and features of the invention will become more apparent from the detailed description of exemplary embodiments of the invention given below with reference to the accompanying drawings.

FIG. 1 is a flow chart illustrating one embodiment of the present invention for determining whether an online transaction is fraudulent using an Online Fraud Mitigation Engine.

FIG. 2 is a block diagram of a computer system for implementing embodiments of the present invention.

FIG. 3 illustrates one embodiment of the present invention useful for calculating a travel velocity.

FIG. 4 illustrates another embodiment of the present invention useful for calculating a travel velocity.

FIG. 5 illustrates one embodiment of the present invention useful for calculating a user's travel velocity.

FIG. 6 illustrates one embodiment of the present invention useful for determining a fraudulent transaction using a travel velocity.

FIG. 7 illustrates one embodiment of the present invention useful for determining a fraudulent transaction using a transaction frequency.

FIG. 8 shows a logical overview of a computer system which may be used to carry out the various embodiments of the present invention.

FIG. 9 illustrates logically the arrangement of computers connected to the Internet in one embodiment of the present invention.

FIG. 10 illustrates one embodiment of the present invention useful for authenticating a transaction.

FIG. 11 illustrates a further embodiment of the present invention useful for authenticating a transaction.

FIG. 12 illustrates yet another embodiment of the present invention useful for authenticating a transaction.

FIG. 13 shows one embodiment of the present invention for providing transparent fraud analysis for an application.

FIG. 14 illustrates logically one embodiment of the present invention for providing fraud analysis for an application.

In the following detailed description, reference is made to the accompanying drawings, which form a part hereof, and in which is shown by way of illustration of specific embodiments in which the invention may be practiced. These embodiments are described in sufficient detail to enable those skilled in the art to practice the invention, and it is to be understood that other embodiments may be utilized, and that structural, logical and programming changes may be made without departing from the spirit and scope of the present invention.

### DETAILED DESCRIPTION OF THE INVENTION

Before the present methods, systems, and computer program products are disclosed and described, it is to be understood that this invention is not limited to specific methods, specific components, or to particular compositions, as such may, of course, vary. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Thus, for example, reference to “an encoder” includes mixtures of encoders, reference to “an encoder” includes mixtures of two or more such encoders, and the like.

The term “risk factor” includes any factor used in a transaction that has some level of risk associated with it.

The term “static risk factor” includes any factor that does not change at run time.

The term “dynamic risk factor” includes any factor that has its value calculated at run time.

The term “risk value” includes any number associated with a factor.

The term “risk weight” includes any number that determines how much influence a factor's risk value has on a risk score.

The term “rule” includes any conditional statement that applies Boolean logic to risk values.

The term “risk score” includes any aggregation of risk values based on a computation of risk values and risk weights or a rule setting the risk score directly.

The term “online fraud mitigation engine” (OFME) includes any component of the present invention that accepts an IP address along with a number of factors to thereby create a risk score for a given transaction which can be used to determine if the transaction is fraudulent.

The term “transaction” includes any type of online activity, such as online banking account access, credit card transactions, online bill pay, wire transfers, stock trades, transactions utilizing personal information, and the like.

The term “transaction identifier” includes any unique system generated number that identifies a particular risk score model.

The term “risk score model” includes any set of logical rules, applicable static and dynamic factors, risk weights for the factors, a fraud score algorithm, a risk score threshold, and reason codes used to identify a fraudulent transaction.

The term “user” or “client” includes one or more persons, entities, or computers.

The terms “method(s)”, “system(s)”, and “computer program product(s)” may be used interchangeably within various embodiments of the present invention.

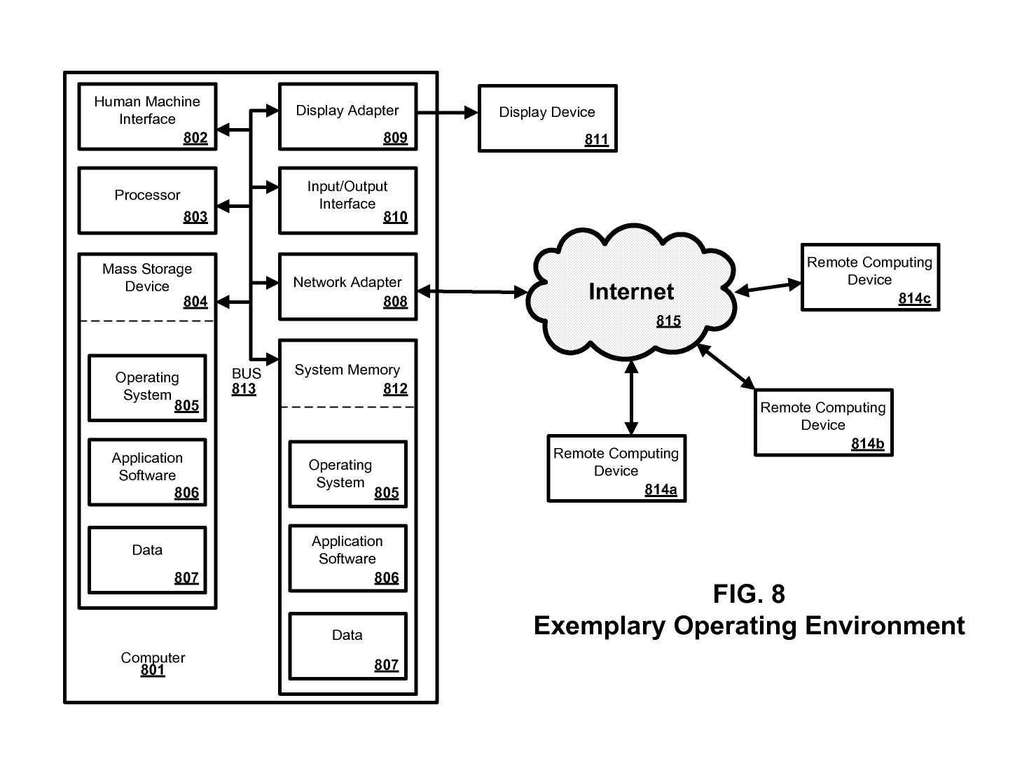

The methods of the present invention can be carried out using a processor programmed to carry out the various embodiments of the present invention. FIG. 8 is a block diagram illustrating an exemplary operating environment for performing the various embodiments. This exemplary operating environment is only an example of an operating environment and is not intended to suggest any limitation as to the scope of use or functionality of operating environment architectures. Neither should the operating environment be interpreted as having any dependency or requirement relating to any one or combination of components illustrated in the exemplary operating environment.

The methods can be operational with numerous other general purpose or special purpose computing system environments or configurations. Examples of well known computing systems, environments, and/or configurations that may be suitable for use with the methods include, but are not limited to, personal computers, server computers, laptop devices, and multiprocessor systems. Additional examples include set top boxes, programmable consumer electronics, network PCs, minicomputers, mainframe computers, distributed computing environments that include any of the above systems or devices, and the like.

The methods may be described in the general context of computer instructions, such as program modules, being executed by a computer. Generally, program modules include routines, programs, objects, components, data structures, etc. that perform particular tasks or implement particular abstract data types. The methods may also be practiced in distributed computing environments where tasks are performed by remote processing devices that are linked through a communications network. In a distributed computing environment, program modules may be located in both local and remote computer storage media including memory storage devices.

The methods disclosed herein can be implemented via a general-purpose computing device in the form of a computer 801. The components of the computer 801 can include, but are not limited to, one or more processors or processing units 803, a system memory 812, and a system bus 813 that couples various system components including the processor 803 to the system memory 812.

The processor 803 in FIG. 8 can be an x-86 compatible processor, including a PENTIUM IV, manufactured by Intel Corporation, or an ATHLON 64 processor, manufactured by Advanced Micro Devices Corporation. Processors utilizing other instruction sets may also be used, including those manufactured by Apple, IBM, or NEC.

The system bus 813 represents one or more of several possible types of bus structures, including a memory bus or memory controller, a peripheral bus, an accelerated graphics port, and a processor or local bus using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus. This bus, and all buses specified in this description can also be implemented over a wired or wireless network connection. The bus 813, and all buses specified in this description can also be implemented over a wired or wireless network connection and each of the subsystems, including the processor 803, a mass storage device 804, an operating system 805, application software 806, data 807, a network adapter 808, system memory 812, an Input/Output Interface 810, a display adapter 809, a display device 811, and a human machine interface 802, can be contained within one or more remote computing devices 814a,b,c at physically separate locations, connected through buses of this form, in effect implementing a fully distributed system.

The operating system 805 in FIG. 8 includes operating systems such as MICROSOFT WINDOWS XP, WINDOWS 2000, WINDOWS NT, or WINDOWS 98, and REDHAT LINUX, FREE BSD, or SUN MICROSYSTEMS SOLARIS. Additionally, the application software 806 may include web browsing software, such as MICROSOFT INTERNET EXPLORER or MOZILLA FIREFOX, enabling a user to view HTML, SGML, XML, or any other suitably constructed document language on the display device 811.

The computer 801 typically includes a variety of computer readable media. Such media can be any available media that is accessible by the computer 801 and includes both volatile and non-volatile media, removable and non-removable media. The system memory 812 includes computer readable media in the form of volatile memory, such as random access memory (RAM), and/or non-volatile memory, such as read only memory (ROM). The system memory 812 typically contains data such as data 807 and and/or program modules such as operating system 805 and application software 806 that are immediately accessible to and/or are presently operated on by the processing unit 803.

The computer 801 may also include other removable/non-removable, volatile/non-volatile computer storage media. By way of example, FIG. 8 illustrates a mass storage device 804 which can provide non-volatile storage of computer code, computer readable instructions, data structures, program modules, and other data for the computer 801. For example, a mass storage device 804 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Any number of program modules can be stored on the mass storage device 804, including by way of example, an operating system 805 and application software 806. Each of the operating system 805 and application software 806 (or some combination thereof) may include elements of the programming and the application software 806. Data 807 can also be stored on the mass storage device 804. Data 804 can be stored in any of one or more databases known in the art. Examples of such databases include, DB2®, Microsoft® Access, Microsoft® SQL Server, Oracle®, mySQL, PostgreSQL, and the like. The databases can be centralized or distributed across multiple systems.

A user can enter commands and information into the computer 801 via an input device (not shown). Examples of such input devices include, but are not limited to, a keyboard, pointing device (e.g., a “mouse”), a microphone, a joystick, a serial port, a scanner, and the like. These and other input devices can be connected to the processing unit 803 via a human machine interface 802 that is coupled to the system bus 813, but may be connected by other interface and bus structures, such as a parallel port, serial port, game port, or a universal serial bus (USB).

A display device 811 can also be connected to the system bus 813 via an interface, such as a display adapter 809. For example, a display device can be a cathode ray tube (CRT) monitor or a Liquid Crystal Display (LCD). In addition to the display device 811, other output peripheral devices can include components such as speakers (not shown) and a printer (not shown) which can be connected to the computer 801 via Input/Output Interface 810.

The computer 801 can operate in a networked environment using logical connections to one or more remote computing devices 814a,b,c. By way of example, a remote computing device can be a personal computer, portable computer, a server, a router, a network computer, a peer device or other common network node, and so on. Logical connections between the computer 801 and a remote computing device 814a,b,c can be made via a local area network (LAN) and a general wide area network (WAN). Such network connections can be through a network adapter 808. A network adapter 808 can be implemented in both wired and wireless environments. Such networking environments are commonplace in offices, enterprise-wide computer networks, intranets, and the Internet 815.

For purposes of illustration, application programs and other executable program components such as the operating system 805 are illustrated herein as discrete blocks, although it is recognized that such programs and components reside at various times in different storage components of the computing device 801, and are executed by the data processor(s) of the computer. An implementation of application software 806 may be stored on or transmitted across some form of computer readable media. An implementation of the disclosed method may also be stored on or transmitted across some form of computer readable media. Computer readable media can be any available media that can be accessed by a computer. By way of example, and not limitation, computer readable media may comprise “computer storage media” and “communications media.” “Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

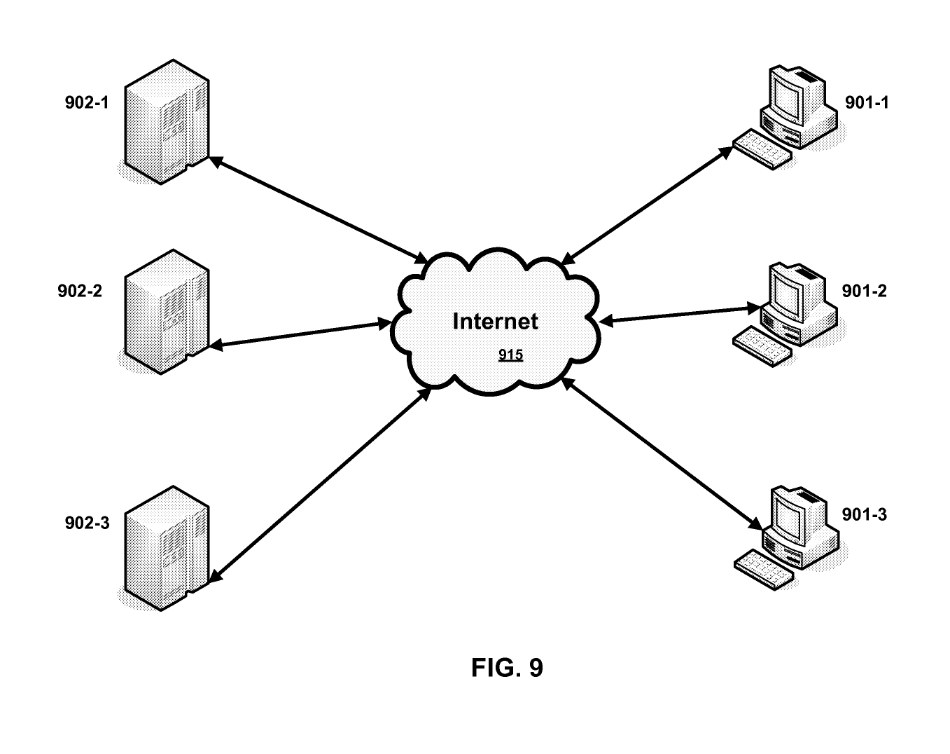

FIG. 9 illustrates a logical overview of the Internet 815 of one embodiment of the present invention. One or more client computers 801, for example, such as the remote computing devices 814a,b,c depicted in FIG. 8, may be connected to the Internet 815 as depicted at 901-1, 901-2, and 901-3. Additionally, one or more computers 902-1, 902-2, and 902-3 of the type depicted at 801 may act as servers, providing web pages via HTTP request, database access, remote terminal services, digital file download or upload, or any other desired service. Furthermore, one or more client computers, such as 901-1, may act as an Internet accessible server computer 902-1, and vice versa.

### Online Fraud Mitigation Engine

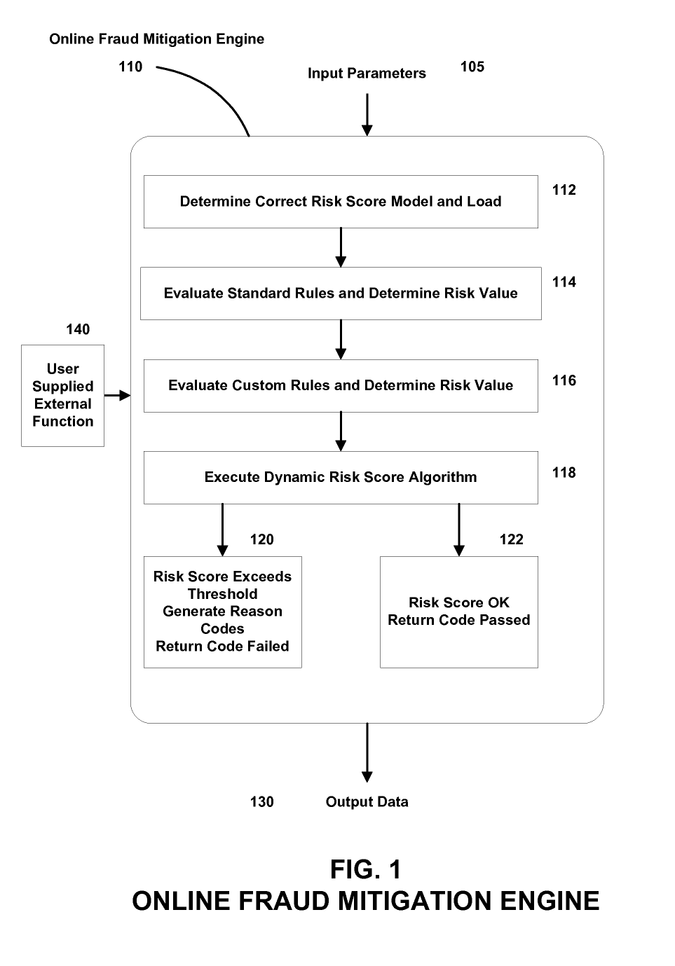

FIG. 1 is a flow chart illustrating steps for performing an online fraudulent transaction determination in accordance with one embodiment of the present invention. At step 105, input parameters are input into the OFME by an end user, for example, a banking institution. The OFME provides a run-time environment for the selected risk score model. The OFME provides a rules based engine for receiving input parameters; for example, a transaction identifier, an IP address, a date/time stamp, a unique identifier and a number of static factors for processing. The OFME subsequently retrieves relevant information regarding an Internet user's IP address; for example, the Internet user's location from a NetAcuity server. The operation of the NetAcuity server is discussed in U.S. patent application Ser. No. 09/832,959, which is herein incorporated by reference in its entirety.

A unique transaction identifier is associated with a given Internet based transaction and is used by the OFME to determine which risk score model should be utilized for a given transaction. The Fraud Risk Advisor uses the transaction identifier for tracking purposes. The results are then stored in a database.

Additional input parameters may be input into the OFME through end user supplied data. For example, the end user may utilize a hot file, suspect IP list, etc., which could be used by the OFME in the determination process. Once the OFME receives the specified input parameters, the Fraud Risk Advisor proceeds to step 112. In step 112, the end user will select from a set of standard risk score models or end user defined risk score models to be used for a particular determination.

After the OFME loads the appropriate risk score model, the present invention proceeds to step 114 in which the OFME evaluates a given set of factors and determines a risk value for each given factor. Once the risk value has been determined for each factor associated with the OFME, the present invention proceeds to step 116 in which the OFME evaluates a given set of rules and determines a risk score.

When the risk score has been determined by a rule match, the present embodiment proceeds to step 118 in which the OFME executes a risk score algorithm to determine an aggregate risk score. The OFME uses the standard risk value from the rules evaluation, as well as an optional static risk score to determine an aggregate risk score. For example, the rules based risk score could be assigned a value between 0 to 1,000. A risk score of 0 would be assigned to a transaction perceived to be highly fraudulent, while a risk score of 1,000 would be assigned to scores perceived to have a low risk of fraud.

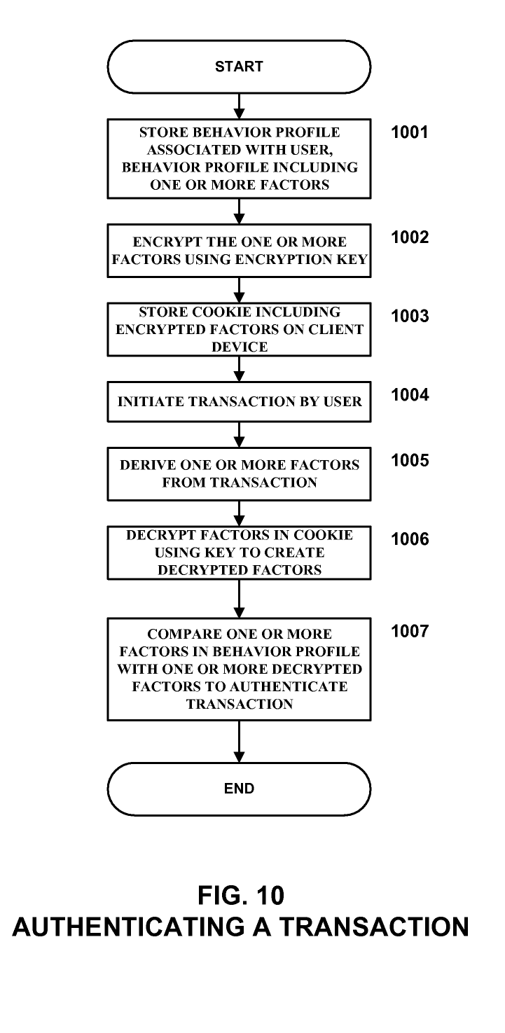

Dependent on the risk score calculated in step 118 and threshold limits defined by an end user, the OFME determines whether the transaction proceeds to step 120 or step 122. If the score exceeds the predefined threshold level, the OFME proceeds to step 120 because the transaction is determined to be fraudulent. Accordingly, the transaction is flagged and forwarded to the end user for further review along with each factor value and a reason code for each factor value. If the score is within predetermined threshold limits, the OFME proceeds to step 122 because the transaction is determined to be valid. In the alternative, if the score is within predetermined threshold limits, the OFME could further authenticate the transaction using one or more embodiments of the present invention drawn to authenticating a transaction using a cookie and a behavior profile, such as the embodiments illustrated in FIGS. 10, 11, and 12.

At step 130, the end user receives output from the OFME for the pending transaction. If the transaction is determined to be fraudulent by the OFME, the end user receives the results from the OFME including factor values and reason codes for the transaction. In addition, the OFME will update the present invention's real-time statistics and store all relevant data, for example, the IP address, regarding the transaction in a database, even if the transaction is deemed valid. The stored data is used for both reporting purposes as well as analysis purposes for updating the risk score model's risk weights or removing certain factors or rules. The end user has the ability to override the results of the OFME and may flag a transaction determined to be valid as suspicious or deem a suspicious transaction valid.

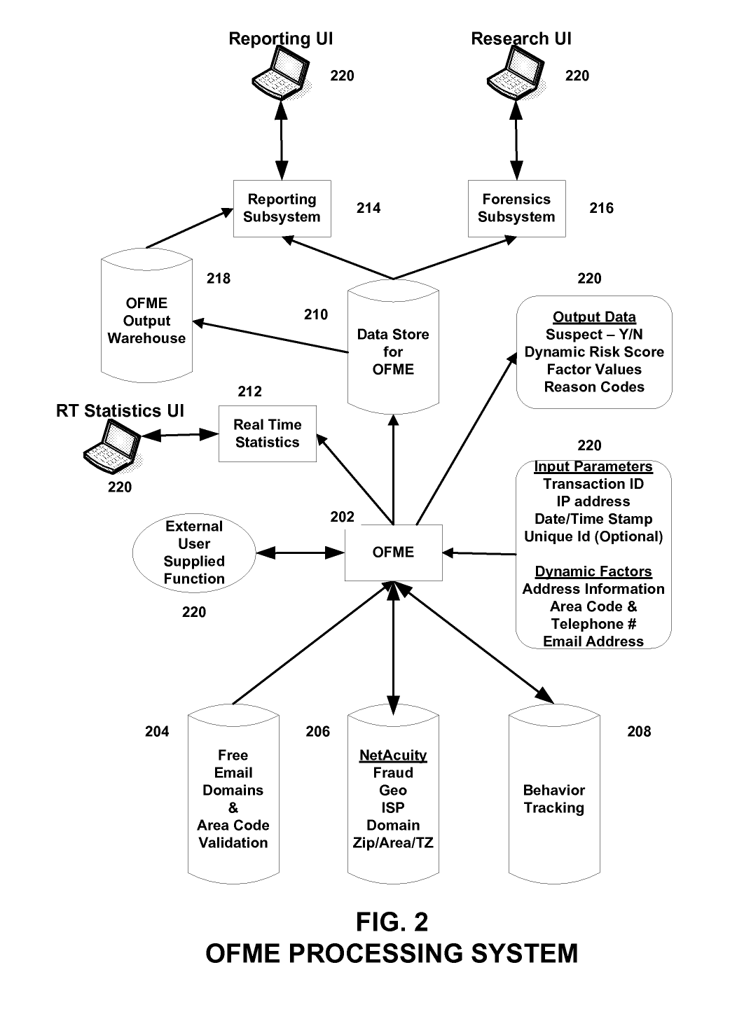

FIG. 2 illustrates is an exemplary processing system 200 with which the invention may be used. System 200 includes a user interface 220 in which an end user may input parameters, rules, and user defined functions to the OFME 202. User interface 220 may comprise multiple user interfaces. The user interface 220 also receives output data from the OFME 202 regarding a certain transaction. The user interface 220 may be graphical or web based, or may use any other suitable input mechanism.

Once the OFME 202 receives data from the user interface 220, the OFME 202 acquires information associated with this data from, for example, a NetAcuity server 206, a validation server 204 and a behavior-tracking database 208. Validation server 204 validates email addresses and area codes supplied by the end user for a given transaction.

Behavior tracking database 208 uses a unique identifier associated with a given Internet user to determine whether a current Internet based transaction is in congruence with the normal behavior of the Internet user. The unique identifier can be anything useful to uniquely identify a user, such as a user name, debit card number, credit card number, bank account number, or social security number. The unique identifier may be user supplied in various embodiments, and can be stored in the searchable behavior-tracking database 208. When the Internet user performs an Internet based transaction, the behavior-tracking database 208 is searched and geographic data along with an ISP and domain, which may also be stored with the unique identifier, is retrieved, if available. This information is then compared to the geographic data, ISP, and domain information associated with a current IP address for the current pending Internet based transaction. The result of the comparison, an access behavior factor, is used to determine whether the current pending Internet based transaction is fraudulent. If an access behavior violation is determined, an automated challenge/response could be used to validate the Internet user accessing an account in real time. If there is no history for the current IP address available in the behavior-tracking database 208 for the Internet user, the current geographic data, ISP and domain information associated with the current IP address is added to the behavior-tracking database 208. Accordingly, when an Internet user is creating an account, access behavior would not be used as a factor for fraud detection. The behavior tracking database 208 may also be used to store one or more behavior profiles described in embodiments of the present invention.

The unique identifier assigned to the Internet user may store multiple access behaviors. In addition, because an Internet user may change their access behavior due to, for example, extended travel, change of residence, etc., the end user may override an access behavior violation returned by the OFME 202.

The OFME 202 uses the information supplied by the user interface 220, NetAcuity server 206, validation server 204 and behavior-tracking database 208 to determine a risk score associated with a given transaction. Once the OFME 202 computes the risk score, the risk score is sent along with any relevant information concerning the transaction to behavior tracking database 208, real time statistics database 212, user interface 220, and OFME data storage database 210.

In one embodiment, OFME data storage database 210 may transfer data received from OFME 202 to OFME output warehouse storage 218 for long-term storage. In addition, OFME data storage database 210 may transfer data received from OFME 202 to both a Reporting subsystem 214 and a Forensics subsystem 216 for processing and output to the user interface 220. Forensics subsystem 216 provides the end user the ability to look-up information generated by running a risk score model. Thus, the end user can determine why a transaction is deemed suspicious or why a transaction was not deemed suspicious. Reporting subsystem 214 provides various reports to the end user, for example, the number of transaction flagged as being suspicious.

### Calculating Travel Velocity

In one embodiment of the present invention, a method is provided for calculating a travel velocity between a first access point and a second access point using a first and second IP address. Calculating a travel velocity has several practical uses, including determining a fraudulent transaction, network analysis, user profiling, user account verification and tracking, network access provider analysis, and advertising. Travel velocity may also be a factor utilized by the OFME 202 to determine a fraudulent transaction.

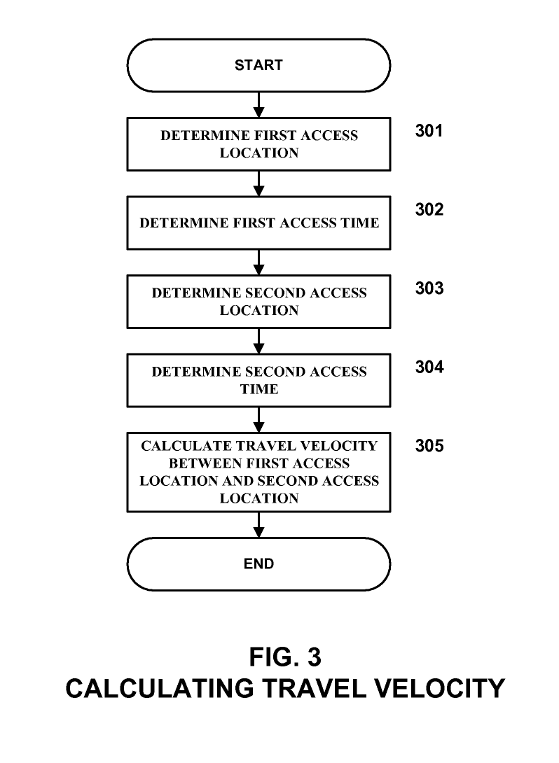

FIG. 3 illustrates one embodiment of the present invention useful for calculating travel velocity. First, a first access location is determined based on a first Internet Protocol (“IP”) address 301. Second, a first access time is determined 302. Third, a second access location is determined based on a second IP address 303. Fourth, a second access time is determined 304. Finally, the travel velocity between the first access location and the second access location is calculated 305 as a function of the first access location 301 and the first access time 302, and the second access location 303 and the second access time 304.

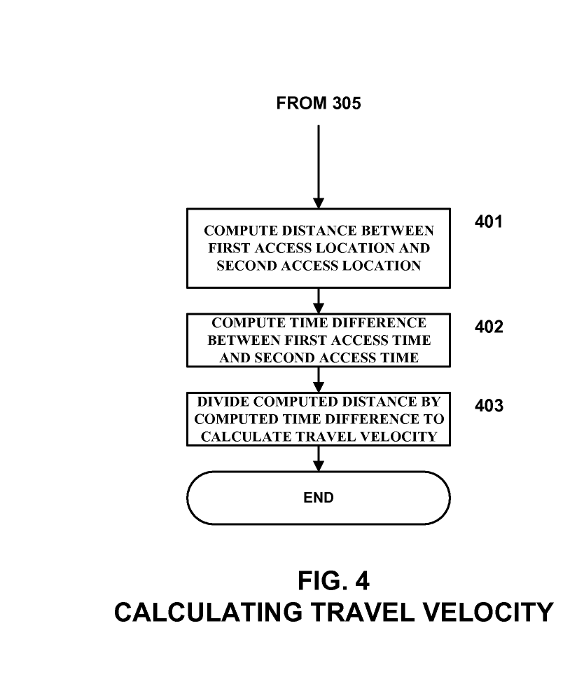

A further embodiment of the present invention useful for calculating a travel velocity is logically illustrated in FIG. 4. While the embodiment of FIG. 4 continues from step 305 of FIG. 3, no particular order of steps is expressly or implicitly required. In this embodiment, a distance between the first access location 301 and the second access location 303 is computed 401. Second, a time difference is computed 402 between the first access time 302 and a second access time 304. Third, the travel velocity is calculated 403 between the first access location 301 and the second access location 303 by dividing the computed distance 401 by the computed time difference 402.

For illustration purposes only, according to the embodiment of FIG. 4, suppose that the first IP address is 24.131.36.54, and the first access time 302 is 1:00 PM EST. Methods for determining the location corresponding to an IP address, such as those provided by a NetAcuity server, are used to determine that the first IP address corresponds to the first location 301 of Atlanta, Ga., USA. Next, a second IP address of 144.214.5.246 is provided, and the second access time 304 is 1:05 PM EST. Again, methods are used to determine that 144.214.5.246 corresponds to a second access location 303 of Hong Kong, China.

Next, the distance between the first access location 301 of Atlanta, and the second access location 303 of Hong Kong, is computed 401 to be approximately 8405 miles. The computed time difference 402 between the first access time 302 of 1:00 PM EST and the second access time 304 of 1:05 PM EST is 5 minutes. Then, the computed distance 401 of 8405 miles is divided by the time difference 402 of 5 minutes, to calculate a travel velocity 403 of 8405 miles/5 minutes, or 100,860 miles per hour, which is suspiciously high.

### Calculating a User's Travel Velocity

In one embodiment of the present invention, a method is provided for calculating a user's travel velocity between a first access location and a second access location using a first and second IP address. Calculating a user's travel velocity has several practical uses, including determining a fraudulent transaction, network analysis, user profiling, user account verification and tracking, network access provider analysis, and advertising. A user's travel velocity may also be a factor utilized by the OFME 202 to determine a fraudulent transaction.

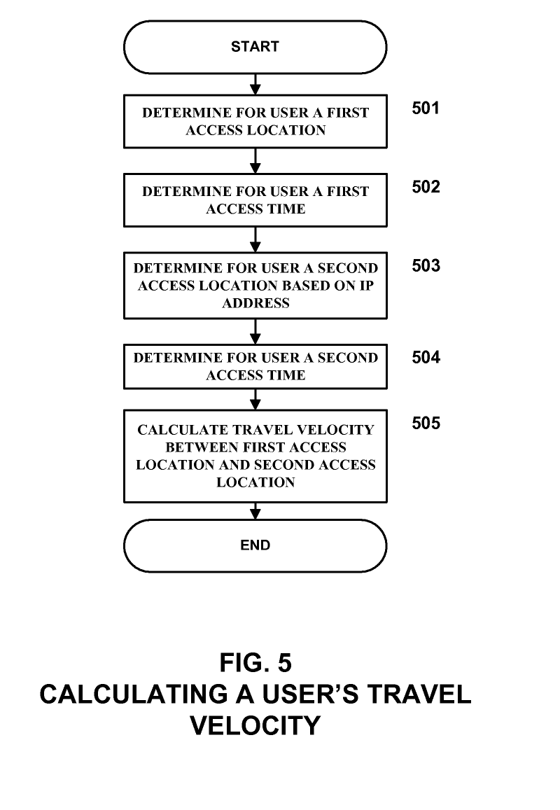

FIG. 5 illustrates one embodiment of the present invention useful for calculating a user's travel velocity. First, a first access location 501 is determined for a user. The first access location 501 may be determined in a variety of ways, such as using the user's IP address to determine the first access location 501, retrieving the first access location 501 from the user's behavior profile, or by using a user supplied first access location 501.

Second, a first access time 502 is determined for the user. A second access location is then determined for the user 503 based on the IP address of the user. Fourth, a second access time is determined for the user 504. Then, the method of the present embodiment calculates the travel velocity 505 of the user between the first access location 501 and the second access location 503. The user's travel velocity may be calculated using a variety of methods, including the method embodied in FIG. 4.

In a further embodiment based on FIG. 5, the first access location 501 and the first access time 502 are determined from a behavior profile associated with the user. In other embodiments, the first access location 501 can be determined based on the user's last valid access location. In another embodiment, the second access location 503 and the second access time 504 are the user's current access location and current access time.

### Determining a Fraudulent Transaction

In one embodiment of the present invention, a method is provided for determining if a transaction is fraudulent by using a user's travel velocity as a fraud factor. Determining if a transaction is fraudulent based upon a user's travel velocity has several practical uses, such as stopping and deterring the theft and use of personal information online, which may result from identify theft, phishing emails, hacking, spy ware, Trojans, and the like. Likewise, the same method may be used to determine if a transaction is legitimate.

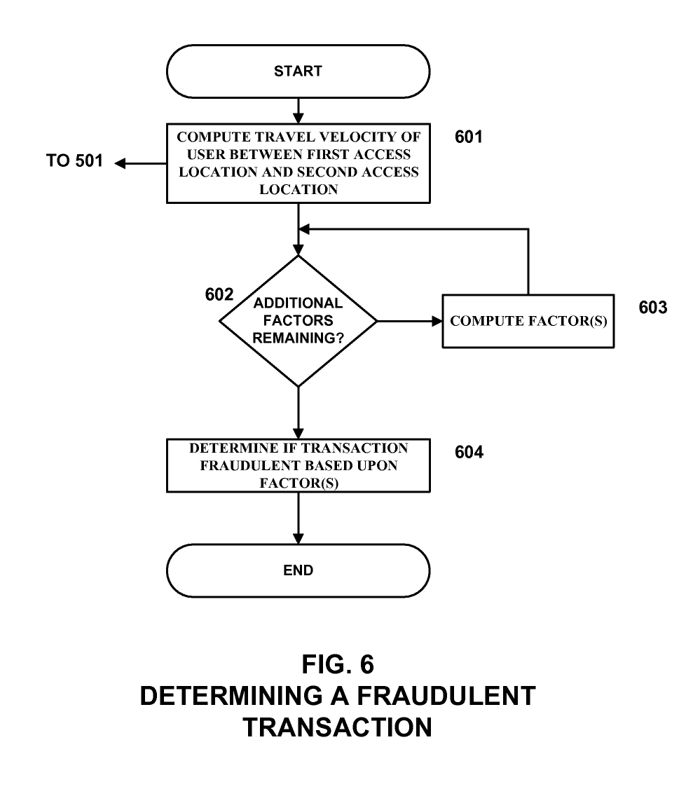

One embodiment of a method for determining if a transaction is fraudulent based upon a user's travel velocity is illustrated in FIG. 6. First, the travel velocity of a user is computed 601 between a first access location and a second access location. One embodiment for calculating a user's travel velocity is provided in FIG. 5 in steps 501 through 505. Other methods for computing a travel velocity may also be employed in the embodiment of FIG. 6. The various embodiments included herein for determining a fraudulent transaction may utilize the OFME 202.

Behavior profiles containing one or more factors may be utilized in the embodiment of FIG. 6 and in other embodiments to determine if a transaction is fraudulent, wherein a factor is at least one of an access location, access date, access time, geographical location, domain information, network Id, connection type, one or more IP addresses, user name, email address, debit card number, credit card number, bank account number, social security number, HTTP header information, travel velocity, telephone number, area code, transaction frequency, operating system, processor identification number, natural language, host type, demographic information, or advertising information. Behavior profiles are useful because they allow one or more variables corresponding to one or more factors to be persistently stored, enabling embodiments to determine not only the travel velocity or likelihood of fraud between a first access location and a second access location, but to determine a pattern of fraudulent activity over a plurality of access locations, times, IP addresses, and the like. The behavior profile may be stored in a database such as the behavior tracking database 208 of the embodiment of FIG. 2.

Second, the method of FIG. 6 determines if one or more additional factors based upon the user's IP address will be computed. While only the user's travel velocity need be computed at 601, additional factors, including factors based upon the user's IP address may be used in various embodiments. The types and number of additional factors computed 603 may vary among the different embodiments to optimize the determination of a fraudulent transaction.

If an additional factor is determined to be remaining 602, then that additional factor is computed 603. Next, the method of FIG. 6 then determines 602 and computes 603 remaining additional factors until no factors remain to be computed, causing the method of FIG. 6 to proceed to step 604.

In one embodiment based on the embodiment of FIG. 6, an additional factor computed 603 comprises a country, region, or city associated with the IP address of the user. In another embodiment extending the embodiment of FIG. 6, a factor computed 603 may be a proximity of the user in comparison to a purported location of the user associated with the IP address. A factor computed 603 also may comprise the connection type of the user, such as dial-up, Integrated Services Digital Network (ISDN), cable modem, Digital Subscriber Line (DSL), Digital Signal 1 (T1), or Optical Carrier 3 (OC3). The factor 603 may also comprise a host type, such as personal network end point, corporate network end point, personal or corporate proxy, personal or corporate firewall, and the like.

Additional embodiments extending the embodiment of FIG. 6 may utilize factors supplied by the user, including an address supplied by a client for comparison with an address associated with the IP address, an area code and telephone number supplied by the client for comparison with an area code and telephone number stored in a database associated with the client, or an email address supplied by the client. User supplied factors are useful to various embodiments of the present invention where the embodiments may assume that the user supplied factors are accurate as they are supplied directly by the user.

Further factors may be utilized by the embodiment of FIG. 6, such as where a factor is an access behavior associated with the user based on transaction habits stored in a database that are compared with a current transaction. A factor may also comprise a frequency with which the transaction is attempted or executed within a predetermined amount of time, or a velocity with which a single IP address accesses or uses multiple unique identifiers within a specified period of time.

In further embodiments of FIG. 6, a client may participate in the determination of factors to be computed at 603. For example, in one embodiment, a client may assign a threshold level for one or more of the factors. The client may also create one or more user defined factors, and the client may also define constraint rules for one or more factors. Allowing the user to determine factors, assign threshold levels for factors, and constraint rules for factors allows the method of FIG. 6 to optimally determine if a transaction is fraudulent in a method tailored to the user.

Next, in the embodiment of FIG. 6, the method determines if the transaction is fraudulent based upon the user's travel velocity and zero or more additional factors, such as those described above. The determination 604 that a transaction is fraudulent or legitimate may occur in real time, near real time, or non-real time, based upon the particular implementation of the method of FIG. 6. The user's travel velocity may be a factor utilized by the OFME 202 to determine a fraudulent transaction, and may be stored in a behavior profile residing in a behavior tracking database 208.

### Transaction Frequency

In one embodiment of the present invention, a method is provided for determining if a transaction is fraudulent by using a computed transaction frequency. A high transaction frequency may be useful, for example, where a user's personal information has been stolen and distributed to one or more individuals who intend to make multiple fraudulent online purchases with the personal information of the user. A high transaction frequency may indicate a fraudulent transaction where a particular transaction is attempted repeatedly from the same IP address within a predetermined period of time.

Likewise, a transaction may be fraudulent where the same or a similar transaction is attempted or executed multiple times and received by or at a single IP address. For example, suppose a person's credit card information is stolen and distributed among a group of persons who intend to use that information to make fraudulent purchases at a particular online retailer who operates an e-commerce server at a particular IP address. According to one embodiment of the present invention, the frequency with which multiple IP addresses attempt or execute a transaction received at a single IP address, such as the address of an e-commerce server, may indicate that a transaction is fraudulent. In further embodiments, the factors discussed above may be incorporated to determine a fraudulent transaction, such as travel velocity or access behaviors retrieved from user profiles.

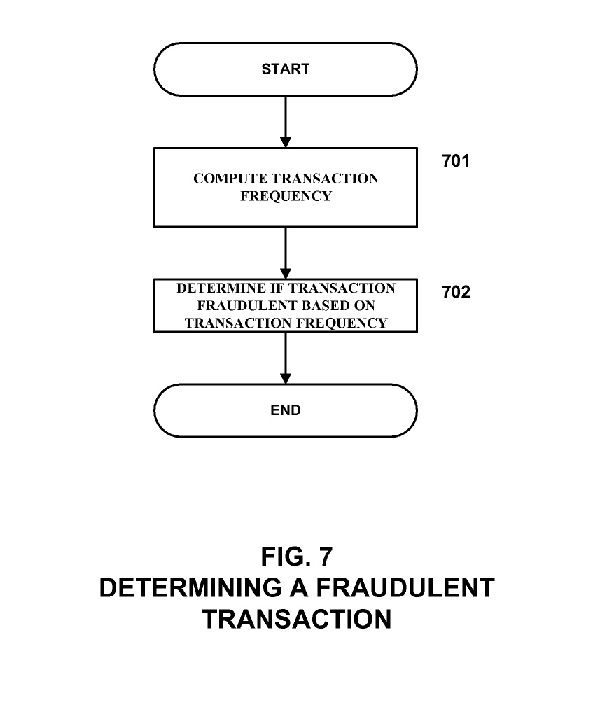

Determining if a transaction is fraudulent based transaction frequency has several practical uses, such as stopping and deterring the theft and use of personal information online, which may result from identify theft, phishing emails, hacking, spy ware, Trojans, and the like. Likewise, the same methods may be used to determine if a transaction is legitimate. The embodiment illustrated in FIG. 7 provides one method for utilizing a transaction frequency to determine a fraudulent transaction.

First, in the embodiment of FIG. 7, a frequency is computed with which a transaction is attempted from a first IP address within a predetermined period of time. For example, if an online purchase transaction originating from a first IP address is attempted or executed a hundred times within an hour, then the embodiment of FIG. 7 may determine that the transaction is fraudulent 702 based upon the computed transaction frequency 701.

The transaction frequency 701 may be computed in various ways, including by dividing the number of times a transaction is attempted or executed over the time period in which those transaction were attempted or executed. The transaction frequency may also be a factor utilized by the OFME 202 of the embodiment of FIG. 2, and stored in a behavior profile residing in a behavior tracking database 208, also of FIG. 2.

Transaction frequency in another embodiment may be combined with the host type of the IP address or other factors to enhance the accuracy of the fraud determination. For example, extending the embodiment of FIG. 7, suppose that one or more transactions have been attempted from an IP address one hundred times within an hour. Without other information, a transaction frequency of 100 attempts per hour from an IP address may indicate a fraudulent transaction. However, if that IP address represents a network proxy or firewall which provides Internet access to multiple users, then a transaction frequency of 100 attempts per hour may in fact not indicate a likely fraudulent transaction. Therefore, comparing the transaction frequency to the host type of the IP address can optimize the fraud determination by decreasing false positives when the IP address represents a proxy, firewall, or other Internet gateway which provides access for multiple users, several of whom may be conducting one or more legitimate transactions. Other factors such as connection type, travel velocity, information retrieved from a behavior profile, geographic location, user supplied factors, and the like, may also be combined with transaction frequency to enhance the accuracy of the fraud determination.

### Authentication Using a Smart Cookie

In embodiments of the present invention, methods are provided for authenticating a transaction using a cookie and a behavior profile associated with a user. The cookie can be described as a ‘smart’ cookie because it resides on a client device and stores information from a behavior profile associated with a user. Thus, contents of the cookie are tied to a behavior profile, providing a robust back-end authentication analysis. Authenticating a transaction has several practical uses, including determining a fraudulent transaction, network analysis, user profiling, user account verification and tracking, network access provider analysis, and advertising. One of skill in the art will recognize that any object can be used in embodiments of the present invention to store data on a client device, including a cookie or a Flash shared object. Further, the cookie of the present invention may be utilized by the OFME 202 to determine a fraudulent transaction.

One embodiment of the present invention useful for authenticating a transaction using a smart cookie is provided in FIG. 10. First in the embodiment of FIG. 10, a behavior profile associated with a user is stored 1001 on a server, with the behavior profile including one or more factors associated with the user. The server of various embodiments of the present invention includes the devices described in the embodiment of FIG. 8, such as computing device 801. The behavior profile of various embodiments may be stored at any location, including a server, an intermediate server, an authentication server, or a client device. The behavior profile of various embodiments of the present invention includes one or more factors associated with the user, wherein a factor is at least one of an access location, access date, access time, geographical location, domain information, network Id, connection type, one or more IP addresses, user name, email address, debit card number, credit card number, bank account number, social security number, HTTP header information, travel velocity, telephone number, area code, transaction frequency, operating system, processor identification number, natural language, host type, demographic information, or advertising information. The behavior profile also includes an encryption key associated with the user. In various embodiments, the encryption key can be chosen by the user or generated for the user.

Second in the current embodiment, the one or more factors associated with the user are encrypted 1002 using the encryption key to create one or more encrypted factors. Any suitable encryption algorithm can be used in the embodiments of the present invention to encrypt the one or more factors, including private key encryption algorithms such as DES and public key encryption algorithms such as RSA.

Fourth in the current embodiment, the user initiates 1004 a transaction using the client device, and one or more factors are derived 1005 from the transaction. The client device of embodiments of the present invention includes the devices described in the embodiment of FIG. 8, such as computing device 801. Sixth, the one or more factors stored in the cookie are decrypted 1006 using the encryption key to create one or more decrypted factors. Finally, in the current embodiment, the transaction is authenticated 1007 by comparing the one or more factors in the behavior profile with the one or more decrypted factors.

In an embodiment of the present invention extending the embodiment of FIG. 10, the transaction is authenticated by comparing the one or more decrypted factors with the one or more factors derived from the transaction. In yet a further embodiment, the transaction is authenticated by comparing the one or more factors in the behavior profile, the one or more decrypted factors, and the one or more factors derived from the transaction. Additionally, the connection type factor of the embodiments can include at least one of dial-up, Integrated Services Digital Network (ISDN), cable modem, Digital Subscriber Line (DSL), Digital Signal 1 (T1), or Optical Carrier 3 (OC3). The host type factor of the embodiments includes at least one of network end point, network proxy, or network firewall.

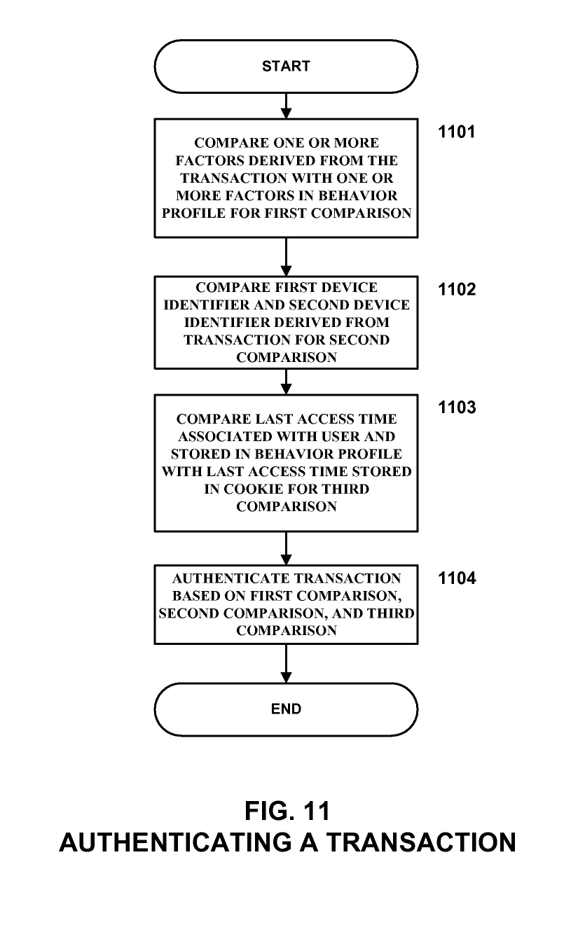

Another embodiment of the present invention useful for authenticating a transaction is described in FIG. 11, which illustrates a method for authenticating a transaction performed by a user operating a client device which contains a cookie, the cookie including at least a first identifier associated with the client device, and wherein a behavior profile is associated with the user and stored on a server. First in the embodiment of FIG. 11, a first comparison is performed 1101 between one or more factors derived from the transaction and one or more factors stored in the behavior profile. Next, a second comparison is performed 1102 between the first device identifier and a second device identifier derived from the transaction. Device identifiers in embodiments of the present invention include HTTP header information such as the ‘User Agent’ string which identifies a web browser. Device identifiers in various embodiments may also be derived from any system information useful for identifying a client device, including information describing the software or the hardware of the client device.

Third in the embodiment of FIG. 11, a third comparison is performed 1103 between a last access time associated with the user which is stored in the behavior profile and a last access time stored in the cookie. Finally, the transaction is authenticated 1104 based on the first comparison, the second comparison, and the third comparison.

In an embodiment of the present invention extending the embodiment of FIG. 11, the behavior profile includes a unique identifier associated with the user. Unique identifiers in embodiments of the present invention include user name, user password, debit card number, bank account number, social security number, or any information useful to uniquely identify a user as understood by one of skill in the art.

In additional embodiments extending the embodiment of FIG. 11, the contents of the cookie are encrypted, and a key to decrypt the cookie is stored in the behavior profile associated with the user. It is further contemplated that the transaction may be authenticated based on the first comparison, the second comparison, the third comparison, and a comparison between an IP address associated with the transaction and a plurality of IP addresses stored in the cookie.

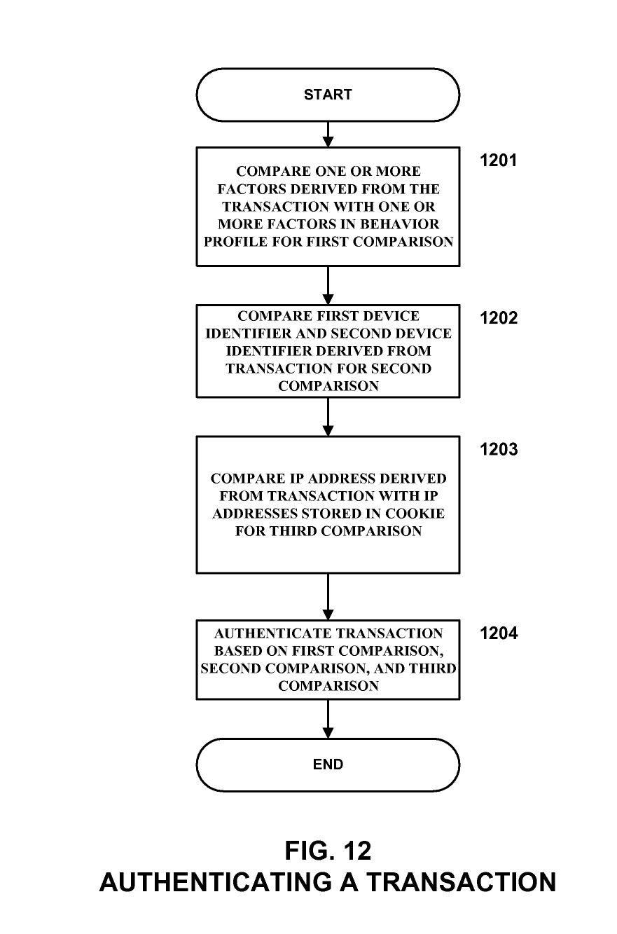

Another embodiment of the present invention useful for authenticating a transaction is described in FIG. 12, which illustrates a method for authenticating a transaction performed by a user operating a client device which contains a cookie, the cookie including at least a first identifier associated with the client device, and wherein a behavior profile is associated with the user and stored on a server. In the embodiment of FIG. 12, a first comparison is performed 1201 between one or more factors derived from the transaction and one or more factors stored in the behavior profile. Second, a second comparison is performed 1202 between the first device identifier and a second device identifier derived from the transaction.

A third comparison is then performed 1203 in the embodiment of FIG. 12 between an IP address derived from the transaction and a plurality of IP addresses stored in the cookie. Finally, the transaction is authenticated 1204 based on the first comparison, the second comparison, and the third comparison.

In an embodiment extending FIG. 12, the behavior profile may include a unique identifier associated with the user. In a further extending embodiment, the contents of the cookie are encrypted and a key to decrypt the cookie is stored in the behavior profile, enabling the contents of the cookie to be decrypted.

### Authentication Proxy

Several embodiments of the present invention provide methods for providing fraud analysis by using a proxy coupled to a fraud determination unit (“FDU”). These embodiments are advantageous because they can provide transparent fraud analysis; that is, embodiments of the present invention can provide fraud analysis for an entity without requiring the entity to directly integrate a fraud determination unit into its platform. These embodiments are advantageous for several reasons.

First, for example, several embodiments of the present invention are advantageous because they allow an entity that uses a third-party hosted platform to bypass the platform provider via the proxy and use embodiments of the FDU for fraud analysis. Second, by using a proxy coupled to a FDU, embodiments of the present invention can provide fraud analysis for entities that use a third-party application without requiring substantial modification of the third-party application. Third, since embodiments of the present invention can provide fraud analysis without requiring the time and expense of substantial platform modifications, the present invention enables entities, such as banks, to quickly provide robust fraud analysis in response to pending time, regulatory, industry, or customer requirements.

In various embodiments of the present invention the proxy may comprise a self contained rack mountable unit operating a variant of the Linux operating system, which enables quick and easy deployment of the proxy. One of skill in the art will realize that other systems can also be used to deploy the proxy, including the embodiments of FIG. 8. Further, in various embodiments the proxy can interface with the FDU using a C++ based real-time API, which enables fast and efficient communications between the proxy and the FDU. One of skill in the art will also realize that any programming language can be used in embodiments of the present invention.

For performing fraud analysis, the FDU can use any single embodiment of the present invention useful for fraud analysis, or it can use any combination of embodiments of the present invention. For example, the FDU of any embodiment of the present invention can be carried out on any suitable computing system, such as embodiments of the operating environment described in FIG. 8. For performing fraud analysis, the FDU can comprise embodiments of the Online Fraud Mitigation Engine as described in FIGS. 1 or 2. The FDU can also determine fraud by calculating and utilizing a travel velocity as illustrated in the embodiments of FIGS. 3, 4, or 5. Similarly, the FDU can determine a fraudulent transaction using the embodiments of FIGS. 6 or 7, and can authenticate a transaction using the embodiments shown in FIGS. 10, 11, or 12. Accordingly, one of skill in the art will understand that the FDU can advantageously utilize combinations of any of the embodiments of the present invention.

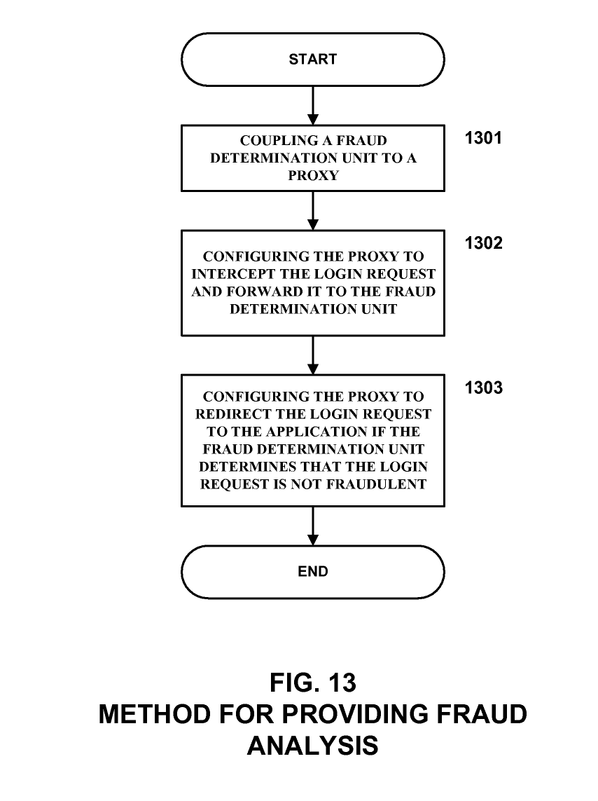

One embodiment of the present invention provides a method, as shown in FIG. 13, for providing transparent fraud analysis for an application that is accessed by a user via a login request. First in the embodiment depicted in FIG. 13, a fraud determination unit is coupled 1301 to a proxy. Second, the proxy is configured 1302 to intercept the login request and to forward the login request to the fraud determination unit. Third, the proxy is configured 1303 to redirect the login request to the application if the fraud determination unit determines that the login request is not fraudulent.

In a further embodiment extending the embodiment of FIG. 13, the proxy can be configured to initiate a session with the application using the login request. This can be accomplished in one embodiment by configuring the proxy to collect one or more objects associated with the session and configuring the proxy to provide at least one of the objects to the user upon being redirected to the application. As discussed with regard to the embodiments shown in FIGS. 10-12, the object of any embodiment of the present invention can comprise any means for storing data on a client device, such as a cookie or a Flash shared object as understood by one of skill in the art.

The proxy can generate and serve the initial login page in one embodiment of the present invention. Generation of the login page by the proxy is useful for those entities that do not or cannot easily create a new login page, such as when a third-party is hosting the entity's web site. The generated page can mimic the look and feel of the entity's web site.

Another embodiment employs personal verification questions to determine if the login request is fraudulent. First in the current embodiment it is determined that the user needs to be associated with personal verifications questions, and then the user is presented with one or more personal verification questions. A personal verification question, as known to one of skill in the art, comprises any statement that solicits an answer from a user, such as “What is your mother's maiden name” or “What is your date of birth.”

Third, it is determined which of the one or more personal verification questions that the user selected for answering. Fourth, the user's answers to the selected personal verification questions are stored, and finally, the one or more selected personal verification questions and answers are associated with the user.

Thus, the current embodiment is useful for creating one or more questions and answers that can later be used to determine if a login request is fraudulent. Indeed, one embodiment of the present invention accomplishes fraud determination by first retrieving a personal verification question, presenting the user with the personal verification question, and then providing by the user an answer to the personal verification question. The FDU then determines whether the login request is fraudulent using the answer to the personal verification question.

In another embodiment extending the embodiment of FIG. 13, the proxy is coupled to a first network for communicating with the application. Then, the proxy is coupled to a second network for communicating with the FDU. The first network can comprise at least one of a local area network, a wide area network, or the Internet. Similarly, the second network can comprise at least one of a local area network, a wide area network, or the Internet.

To enhance security, one embodiment of the present invention can use a virtual private network for communications over the Internet between the FDU and the proxy. In another embodiment, the proxy and the FDU reside on a local area network, and the proxy communicates with the application using the Internet. Further, the proxy and the FDU can reside on the same computer.

The FDU of the present invention is advantageous because, in various embodiments, it can be coupled to a plurality of proxies that are associated with different entities. Thus, a single FDU can communicate with a first proxy associated with a bank and with a second proxy associated with an on-line vendor, and perform fraud analysis for both.

The embodiment of FIG. 13 can be extended to perform fraud determination based on one or more factors. First, one or more factors are computed based on an IP address associated with the login request. Second, the FDU determines whether the login request is fraudulent based on the one of more factors. In one embodiment, a factor can be the travel velocity of the user between a first access location and a second access location. The first access location can be determined using the IP address, and the user's travel velocity can be calculated as a function of the first access location, a first access time, a second access location, and a second access time.

Any of the factors of the present invention can be used by the FDU to determine if the login request is fraudulent. For example, a factor used by the FDU can be the frequency with which the login request is attempted within a period of time, or a factor can be a velocity with which the IP address of the user accesses or uses multiple unique identifiers within a specified period of time. A factor used by the FDU can also comprise at least one of a connection type associated with the IP address or a host type associated with the IP address, wherein connection type comprises dial-up, Integrated Services Digital Network (ISDN), cable modem, Digital Subscriber Line (DSL), Digital Signal 1 (T1), or Optical Carrier 3 (OC3), and wherein host type comprises network end point, network proxy, or network firewall.

FIG. 13 can further be extended to produce another embodiment that uses an object, such as a cookie or Flash shared object, and a behavior profile to determine if the login request is fraudulent. First, a behavior profile that is associated with the user is stored, with the behavior profile including one or more factors associated with the user and including an encryption key associated with the user. Second, the one or more factors are encrypted using the encryption key to create one or more encrypted factors. An object is then stored on a client device of the user, with the object including the one or more encrypted factors. Fourth, the user generates the login request using the client device, and fifth, one or more factors are derived from the login request. Sixth, the one or more factors stored in the object are decrypted to create one or more decrypted factors. Finally, the FDU compares the one or more factors in the behavior profile with the one or more decrypted factors to determine if the login request is fraudulent.

Another embodiment based on the embodiment of FIG. 13 that uses an object and a behavior profile can also be constructed. First, in the current embodiment, an object is stored on a client device associated with the user, with the object including at least a first identifier associated with the client device. A behavior profile is associated with the user. Second, the user generates a login request using the client device.

Third, a first comparison is performed between the one or more factors derived from the login request and one or more factors stored in the behavior profile. Fourth, a second comparison is performed between the first device identifier and a second device identifier derived from the login request. Fifth, a third comparison is performed between a last access time associated with the user and stored in the behavior profile and a last access time stored in the object. Finally, the FDU determines whether the login request is fraudulent based on the first, second, and third comparisons. In a further embodiment, the third comparison can be between an IP address derived from the transaction and a plurality of IP addresses stored in the object.

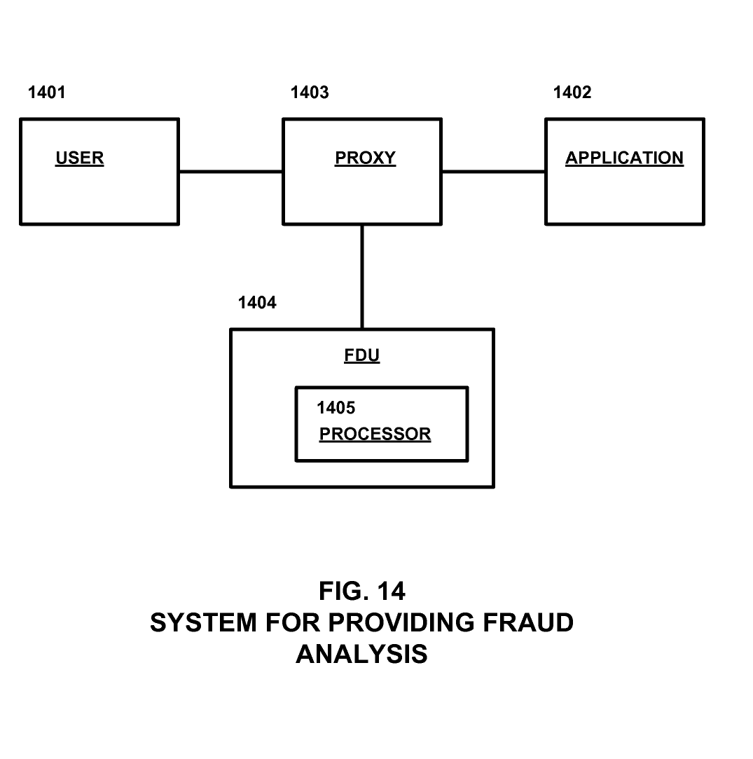

A further embodiment of the present invention comprises a system for providing fraud analysis for an application, and is shown in FIG. 14. As seen in FIG. 14, the system comprises a user 1401 that accesses an application 1402 via a login request. A proxy 1403 is configured to intercept the login request. The system also comprises a FDU 1404 comprising a processor 1405 programmed to perform the steps of receiving the login request from the proxy 1403; determining whether the login request is fraudulent, and if the processor 1405 determines that the login request is not fraudulent, notifying the proxy 1403 that the login request is not fraudulent.

In one embodiment extending the embodiment of FIG. 14, the proxy 1403 communicates with the FDU 1404 using the Internet. The proxy 1403 can also communicate with the application 1402 using the Internet. Further, the proxy 1403 and the FDU 1404 can reside on the same local area network, and can reside on the same computer. The FDU 1404 can be coupled to a plurality of proxies associated with different entities. Finally, as is understood by one of skill in the art, the processor 1405 of the FDU 1404 can be programmed to perform any of the methods of the embodiments of the present invention, including the embodiments shown in FIGS. 1-7 and 10-14.

While the invention has been described in detail in connection with exemplary embodiments, it should be understood that the invention is not limited to the above-disclosed embodiments. Rather, the invention can be modified to incorporate any number of variations, alternations, substitutions, or equivalent arrangements not heretofore described, but which are commensurate with the spirit and scope of the invention. Specific embodiments should be taken as exemplary and not limiting. For example, the present invention may be used in a web-based application. Accordingly, the invention is not limited by the foregoing description or drawings, but is only limited by the scope of the appended claims.

We claim:

1. A method for providing transparent fraud analysis for an application, wherein the application is accessed by a user via a login request, the method comprising the steps of:
a. coupling a fraud determination unit to a proxy;
b. configuring the proxy to intercept the login request and to forward the login request to the fraud determination unit; and
c. configuring the proxy to redirect the login request to the application if the fraud determination unit determines that the login request is not fraudulent.

2. The method of claim 1, further comprising the step of configuring the proxy to initiate a session with the application using the login request.

3. The method of claim 2, further comprising the steps of:
a. configuring the proxy to collect one or more objects associated with the session; and
b. configuring the proxy to provide at least one of the objects to the user upon being redirected to the application.

4. The method of claim 1, further comprising the steps of:
a. determining that the user needs to be associated with personal verification questions;
b. presenting one or more personal verification questions to the user;
c. determining which of the one or more personal verification questions that the user selected for answering;
d. storing the user's answers to the selected personal verification questions; and
e. associating the one or more selected personal verification questions and answers with the user.

5. The method of claim 4, further comprising the steps of:
a. retrieving a personal verification question;
b. presenting the user with the personal verification question;
c. providing by the user an answer to the personal verification question; and
d. determining by the fraud determination unit whether the login request is fraudulent using the answer to the personal verification question.

6. The method of claim 1, further comprising the steps of:
a. coupling the proxy to a first network for communicating with the application; and
b. coupling the proxy to a second network for communicating with the fraud determination unit.

7. The method of claim 6, wherein the first network comprises at least one of a local area network, a wide area network, or the Internet.

8. The method of claim 6, wherein the second network comprises at least one of a local area network, a wide area network, or the Internet.

9. The method of claim 1, wherein the proxy communicates with the fraud determination unit over the Internet using a virtual private network.

10. The method of claim 1, wherein the proxy and the fraud determination unit reside on a local area network, and wherein the proxy communicates with the application using the Internet.

11. The method of claim 10, wherein the proxy and the fraud determination unit reside on the same computer.

12. The method of claim 1, wherein the fraud determination unit is coupled to a plurality of proxies that are associated with different entities.

13. The method of claim 8, wherein the fraud determination unit is coupled to a plurality of proxies that are associated with different entities.

14. The method of claim 1, further comprising the steps of:
a. computing one or more factors based on an IP address associated with the login request; and
b. determining by the fraud determination unit whether the login request is fraudulent based on the one or more factors.

15. The method of claim 14, wherein one factor is the travel velocity of the user between a first access location and a second access location.

16. The method of claim 15, wherein the user's travel velocity is determined according to the steps of:
a. determining for the user the first access location using the IP address;
b. determining for the user a first access time using the login request;
c. determining for the user the second access location;
d. determining for the user a second access time; and
e. calculating the user's travel velocity between the first access location and the second access location as a function of the first access location and the first access time and the second access location and the second access time.

17. The method of claim 14, wherein the proxy and the fraud determination unit communicate over the Internet.

18. The method of claim 14, wherein the fraud determination unit is coupled to a plurality of proxies that are associated with different entities.

19. The method of claim 14, wherein a factor is a frequency with which the login request is attempted within a predetermined period of time.

20. The method of claim 14, wherein a factor is a velocity with which the IP address accesses or uses multiple unique identifiers within a specified period of time.

21. The method of claim 14, wherein a factor comprises at least one of a connection type associated with the IP address or a host type associated with the IP address, wherein connection type comprises dial-up, Integrated Services Digital Network (ISDN), cable modem, Digital Subscriber Line (DSL), Digital Signal 1 (T1), or Optical Carrier 3 (OC3), and wherein host type comprises network end point, network proxy, or network firewall.

22. The method of claim 1, further comprising the steps of:
a. computing a frequency with which one or more other login requests have been attempted from an IP address associated with the login request;
b. determining a host type associated with the IP address, and
c. determining by the fraud determination unit whether the login request is fraudulent using the frequency and the host type.

23. The method of claim 1, further comprising the steps of:
a. storing a behavior profile associated with the user, the behavior profile including one or more factors associated with the user, the behavior profile also including an encryption key associated with the user;
b. encrypting the one or more factors using the encryption key to create one or more encrypted factors;
c. storing an object on a client device of the user, the object including the one or more encrypted factors;
d. generating by the user the login request using the client device;
e. deriving one or more factors from the login request;
f decrypting the one or more factors stored in the object using the encryption key to create one or more decrypted factors; and
g. comparing by the fraud determination unit the one or more factors in the behavior profile with the one or more decrypted factors to determine if the login request is fraudulent.

24. The method of claim 23, wherein the object comprises at least one of a Flash shared object or a cookie.

25. The method of claim 5, further comprising the steps of:
a. storing an object on a client device associated with the user, wherein the object includes at least a first identifier associated with the client device, and wherein a behavior profile is associated with the user;
b. generating by the user the login request using the client device;
c. performing a first comparison between one or more factors derived from the login request and one or more factors stored in the behavior profile;
d. performing a second comparison between the first device identifier and a second device identifier derived from the login request;
e. performing a third comparison between a last access time associated with the user and stored in the behavior profile and a last access time stored in the object; and
f determining by the fraud determination unit whether the login request is fraudulent based on the first comparison, the second comparison, and the third comparison.

26. The method of claim 25, wherein the object comprises at least one of a Flash shared object or a cookie.

27. The method of claim 9, further comprising the steps of:
a. storing an object on a client device associated with the user, wherein the object includes at least a first identifier associated with the client device, and wherein a behavior profile is associated with the user;
b. generating by the user the login request using the client device;
c. performing a first comparison between one or more factors derived from the login request and one or more factors stored in the behavior profile;
d. performing a second comparison between the first device identifier and a second device identifier derived from the login request;
e. performing a third comparison between an IP address derived from the login request and a plurality of IP addresses stored in the object; and
f. determining by the fraud determination unit whether the transaction is fraudulent based on the first comparison, the second comparison, and the third comparison.

28. The method of claim 27, wherein the object comprises at least one of a Flash shared object or a cookie.

29. A system for providing fraud analysis for an application, the system comprising:
a. a user that accesses the application via a login request;
b. a proxy configured to intercept the login request; and
c. a fraud determination unit comprising a processor programmed to perform the steps of:
i. receiving the login request from the proxy;
ii. determining whether the login request is fraudulent; and
iii. if the processor determines that the login request is not fraudulent, notifying the proxy that the login request is not fraudulent.

30. The system of claim 29, wherein the proxy communicates with the fraud determination unit using the Internet.

31. The system of claim 29, wherein the proxy communicates with the application using the Internet.

32. The system of claim 31, wherein the proxy and the fraud determination unit reside on the same local area network.

33. The system of claim 32, wherein the proxy and the fraud determination unit reside on the same computer.

34. The system of claim 30, wherein the fraud determination unit is coupled to a plurality of proxies associated with different entities.

35. The system of claim 34, wherein the processor of the fraud determination unit is further programmed to perform the steps of:
a. determining that the user needs to be associated with personal verification questions;
b. presenting one or more personal verification questions to the user;
c. determining which of the one or more personal verification questions that the user selected for answering;
d. storing the user's answers to the selected personal verification questions; and
e. associating the one or more selected personal verification questions and answers with the user.

36. The system of claim 35, wherein the processor of the fraud determination unit is further programmed to perform the steps of:
a. retrieving a personal verification question;
b. presenting the user with the personal verification question; and
c. determining whether the login request is fraudulent using an answer to the personal verification question.

37. The system of claim 36, wherein the processor of the fraud determination unit is further programmed to perform the steps of:
a. initiating a session with the application using the login request;
b. collecting one or more objects associated with the session; and
c. providing at least one of the objects to the user upon being redirected to the application.

38. The system of claim 37, wherein the object comprises at least one of a Flash shared object or a cookie.
